(19) United States
(12) Patent Application Publication
(10) Pub. No.: US 2003/0220934 A1
(43) Pub. Date: Nov. 27, 2003

(54) Integrated lists and transformation method

(76) Inventor: Petr Hejl, White Rock (CA)

Correspondence Address: Vermette & Co., Granville Square, Suite 230, 200 Granville Street, Box 40, Vancouver, BC, V6C 1S4, CA

(21) Appl. No.: 10/445,005

(22) Filed: May 27, 2003

(30) Foreign Application Priority Data
May 24, 2002 (CA) 2,387,453

(51) Int. Cl. G06F 17/00

(52) U.S. Cl. 707/101

(57) ABSTRACT

A method of transforming categories and records from one list to another. By transforming several simple lists (sublists) into one list, an integrated list is created.

### FIELD

The present invention relates to the transformation of various systems of categories into one unified system of categories and the transformation of records of various lists into records of one integrated list. The integrated lists are constructed from other lists. The transformation method is applied to construct the integrated lists.

### BACKGROUND

Definitions and Explanations

Reality is the world.

Real categories are sets of parts of the reality.

Parts of the reality are subjects, objects, people, animals, things, activities.

Word categories are sets of words, which name (define, describe) real categories.

Examples of (real as well as word) categories are Institutions, Cars, Women, Cats, Toys, Production, Reading . . .

Lists are sets of records, which describe parts of reality and which are divided into categories. The term “lists” includes for the purpose of this patent application also directories, business directories, indices and yellow pages. The records are inserted into lists mostly by hand—they must be placed into proper categories. The records are searched in lists mostly by level-by-level searching of the system of categories until the desired category is reached. Searching using keywords is also possible.

The lists may be stored on different media—Internet, computers, CD-ROMs etc. In Internet, the records in lists are named links, and usually contain the WWW address of some WWW pages and description of these WWW pages. In the Internet, the searching in lists is mostly performed by mouse clicking on the names of the categories.

An example of a list is Yahoo.

Search engines are sets of records, which describe parts of reality and which are not divided into categories or the number of their categories is very low. The term “search engines” includes for the purpose of this patent application also white pages. The records are inserted into search engines mostly by active searching, performed by these search engines. The records are searched in search engines mostly by specifying the keywords, which the searched records should contain. The search engines are usually stored and performed on the Internet. On the Internet, the records in search engines are named links, and usually contain the WWW address of some WWW pages and description of these WWW pages. On the Internet, searching with search engines is performed mostly by writing keywords into the search form window and by mouse clicking on the button Send or Search. Examples of search engines are Google, Alta Vista, Lycos, Excite, Infoseek.

The main difference between lists and search engines is, that lists are ,,categories based”, while search engines are not ,,categories based”.

For the purpose of this patent application the term ,,integrated” means to be composed from many subsystems. Synonyms for this term are, for example, all-in-one, complex, meta, multi, super, hyper. An integrated list is composed from other lists, an integrated search engine is composed from other search engines, etc.

Present State

There are many integrated search engines. A search engine, which is integrated from other search engines, is simply a mathematical union of these search engines. The integrated search engine contains all records, which are contained in the original search engines, of which the integrated search engine is composed. When the user searches records in the integrated search engine using keywords written into the search form window, the integrated search engine first makes the same query to each search sub-engine from which it is composed, and then writes (all) the resulting records from these searches to the user.

But there is no integrated list yet, which would be composed from other lists. The problem is that various lists have mutually different systems of categories. Nobody has realized that it is possible to transform the categories of various lists into one unified system of categories. Neither has anyone disclosed how to realise such transformation.

Lists

directories

business directories

indices

yellow pages

. . .

Search Engines

white pages

. . .

WHAT: Integrated Lists

I suggest here to patent the idea to construct integrated lists, i.e. such lists, which are composed of or constructed from other lists.

HOW: Transformation Method

The transformation method disclosed herein constructs integrated lists by transforming various systems of categories into one unified system of categories and transforms records of various lists into records of the integrated list.

Procedure:

1. Names of Categories of the Integrated List

First define (write, suggest, construct), the names of the categories of the integrated list. These names of categories may be constructed anew, independently and perhaps even without any relation to the categories of the original sublists from which the integrated list will be composed. But as the focus of the integrated list (dedicated branch of interest) is usually the same or very near to the focus of the sublists, it is probable that the names of the categories of the integrated list will be similar to the names of the categories of the sublists from which the integrated list will be composed.

2. Relations Between Categories of the Integrated List

Define relations between the categories of the integrated list, the names of which were defined in step one of this procedure. For example, for every category define its superior category and all the subcategories of this category.

3. Suggestion of Categories Transformation Pairs by Computer Program

The purpose of this step is to suggest the transformation of the categories of the sublists into the categories of the integrated list. For every sublist of the integrated list, for every category of this sublist and for every category of the integrated list analyse and compare the names of these two categories. The following situations may occur:

3.1. Names are Identical

When the name of the category of the sublist is identical to the name of the category of the integrated list, then it is suggested by the program, that this category of the sublist will be transformed into this equally named category of the integrated list.

3.2. Name of Category of Sublist is Part of Name of Category of Integrated List

When the name of the category of the sublist is part of the name of the category of the integrated list, then it is suggested by the program, that this category of the sublist will be transformed into this category of the integrated list.

3.3. Part is Contained

When some meaningfull part (not such words as ,,and, or . . . ”) of the name of the category of the sublist is contained in the name if the category of the integrated list, then it is suggested by the program, that this category of the sublist will be transformed into this category of the integrated list.

3.4. Synonym is Contained

When a synonym of some meaningful part of the name of the category of the sublist is contained in the name of the category of the integrated list, then it is suggested by the program, that this category of the sublist will be transformed into this category of the integrated list. By the term “synonym” equivalent or similar words are meant, e.g. Autos and Cars.

4. Person's Decision

After the program suggestions are ready, some person(s) will go through possibly all the suggested transformation pairs of categories and will decide, i.e. confirm, reject or change the transformations suggested. The person(s) choose(s) one of suggested transformations, define transformation to other category, create a new category in the integrated list and transform the category of the sublist to this new category etc.

5. Transformation of Records

For every sublist of the integrated list and for every category of this sublist do the following: transform (project, move, place) all the records of this category to all the categories of the integrated list, to which this category of the original sublist is to be transformed (as defined in step four of this procedure).

Or, alternativly, for every sublist of the integrated list and for every record of this sublist and for every category of this sublist, to which this record belongs do the following: transform (project, move, place) this record into all the categories of the integrated list, to which this category of the original sublist is to be transformed (as defined in step four of this procedure).

Remark 1

The relations between the categories in the original sublists are not substantial. Transfomation is made only using the names of the categories. The relations between the categories of the integrated list are defined ad hoc in step two of this procedure

Remark 2

As for step three of this procedure, it is also recommended to examine and compare various forms of words, i.e. Car and Cars, and various forms of synonyms, i.e. Car, Cars, Auto, Autos.

Example how to Create Part of Integrated List Using the Transformation Method

Subcategories of the Category Vehicles in the Integrated List

Agricultural Vehicles

Autos

ATV (All Terrain Vehicles)

Bicycles

Buses

Carriages

Construction Vehicles

Motorcycles

RV (Recreational Vehicles)

Trailers

Trains

Streetcars

Subways

Trolleycars

Trucks

Subcategories of the Category Automotive in the Sublist

ATV

Bulldozers

Buses

Cars

Lorries

Metros

Motorcycles

RV

Tractors

Tramways

Trolley Buses

Trucks

Transformation of Categories—Program Suggestion

These suggestions of computer program are base for person's decisions how to transform the categories.

The following is a number of examples of the projection of categories category of the original sublist-→category of the integrated list—ground of suggestion is stated here:

ATV-→ATV (All Terrain Vehicles)—name in sublist is part of name in integrated list

Bulldozers-→?—no suggestion, i.e. find category, create new category in integrated list or ignore

Buses-→Buses—names are equal

Cars-→Autos—synonymum

Lorries-→?—no suggestion, i.e. find category, create new category in integrated list or ignore

Metros-→Subways—synonymum

Motorcycles-→Motorcycles—names are equal

RV-→RV (Recreational Vehicles)—name in sublist is part of name in integrated list

Tractors-→?—no suggestion, i.e. find category, create new category in integrated list or ignore

Tramways-→Streetcars—synonymum

Trolley Buses-→Trolleycars—synonymum

Trucks-→Trucks—names are equal

Transformation of Categories—Person's Decision

A person goes through the pair transformation suggestions and decides whether the computer designations are correct or not.

The resulting examples listed below are manually reviewed and corrected ones category of the original sublist-→category of the integrated list is stated here:

ATV-→ATV (All Terrain Vehicles)

Buses-→Buses

Bulldozers-→Construction Vehicles

Cars-→Autos

Lorries-→Utility Cars (new category will be created)

Metros-→Subways

Motorcycles-→Motorcycles

RV-→RV (Recreational Vehicles)

Tractors-→Agricultural Vehicles

Tramways-→Streetcars

Trolley Buses-→Trolleycars

Trucks-→Trucks

Transformation of Records

Records of the category ATV of the sublist will be transformed (projected, moved, placed) to the category ATV (All Terrain Vehicles) of the integrated list. Records of the category Buses of the sublist will be transformed (projected, moved, placed) to the category Buses of the integrated list.

Records of the category Trucks of the sublist will be transformed projected, (moved, placed) to the category Trucks of the integrated list.

Application

Now, it is possible to construct integrated lists from various sublists. Transformation method is used to transform categories of various lists into categories of the integrated list and to transform records of various lists into records of the integrated list.

I claim:

1. (i) A method of constructing integrated lists, comprising:
a. defining a system of categories of said integrated list;
b. transforming categories and records of sublists to said integrated lists:
(i) establishing suggested projections of categories of the sublist to categories of the integrated list by comparing names of said sublist categories to names of said integrated list categories;
(ii) reviewing said suggested projections and accepting or declining said suggestions;
(iii) transferring all records from said sublist categories to corresponding integrated list categories.
